(19) United States
(12) Patent Application Publication
(10) Pub. No.: US 2018/0187334 A1
(43) Pub. Date: Jul. 5, 2018

(54) FIBER REFINING MACHINE AND PROCESS

(71) Applicant: Johnson & Johnson Consumer Inc., Skillman, NJ (US)

(72) Inventors: Kenneth Pelley, Skillman, NJ (US); Michael Moscherosch, Skillman, NJ (US); John Poccia, Skillman, NJ (US)

(21) Appl. No.: 15/230,064

(22) Filed: Aug. 5, 2016

(51) Int. Cl. D01B 1/00; B04C 9/00; B04C 3/06

(52) U.S. Cl. CPC D01B 1/00; B04C 2009/008; B04C 3/06; B04C 9/00

(57) ABSTRACT

This application provides, at least in part, a fiber refining machine and a method of using the same. The fiber refining machine includes a fiber feeding assembly, a rotary brush assembly and a rotary cutter assembly. The fiber feeding assembly comprises a feeding nip formed between a rotatable roll a nose bar and configured to feed a fibrous material through the nip. The rotary brush assembly includes a wire wheel positionable downstream of the feeding nip and configurable to comb the fed fibrous material to remove connective tissue and/or resinous coating therefrom and to separate the combed fibrous material into individual fibers. The rotary cutter assembly includes at least one rotatable knife and a stationary anvil, the rotary cutter assembly configurable to receive and cut the separated individual fibers into predetermined lengths.

### BACKGROUND OF THE INVENTION

The present invention generally relates to a machine for refining natural fibers and a process of using the same and, more particularly, to a machine for removing connective tissue and/or resinous coating from natural fibers and a process of using the machine to (i) produce refined, individually separated fibers; and (ii) cut the refined, individually separated, fibers into segments of predetermined lengths.

The following discussion of the background of the invention is merely provided to aid the reader in understanding the invention and is not admitted to describe or constitute prior art to the present invention.

Natural fibers include abaca, alpaca, angora, camel, cashmere, coir, cotton, flax, hemp, jute, mohair, ramie, silk, sisal, wool, banana, coconut, bagasse fibers, and other plant fibers. Natural fibers are used in ships' rigging, sturdy manila envelopes, clothing, curtains, screens, furnishing, stencil papers, cigarette filter papers, tea-bags, sausage skins, currency papers, and sanitary products. As a result, thousands of metric tons of these fibers are produced annually in many regions of the world and exported to many others.

U.S. Pat. No. 4,001,916 discloses feed mechanisms for fiber processing machines, including, as illustrated in FIG. 10, a carding machine, including a feed plate 188 and a feed roller 190 being spaced from each other to define a nip therebetween and configured to convey fibrous material to a main carding roll 192 proximately disposed adjacent to the nip. The main carding roll 192 has toothed peripheral surface with combing elements configured to engage a gross mass of tangled, randomly oriented fibers to form fine fiber strips.

U.S. Pat. No. 3,656,672 discloses a machine for splitting plastic sheet materials such as polyethylene films and ribbons into fibrous structures. As illustrated in FIG. 11, the machine includes a rotatable guide roll 194 having a peripheral surface 196 and a stationary nip blade 198 disposed sufficiently adjacent thereto so as to form a nip with the peripheral surface of the guide roll 194, and a rotating brush wheel 200 disposed immediately downstream of the stationary nip blade 198. When in use, a polyethylene film or ribbon 202 is fed in a first direction through the nip between the rotatable guide roll 194 and the stationary nip blade 198, which moves the polyethylene film or ribbon 202 in a second direction that is at an acute angle relative to the first direction. Simultaneously with the change in direction of the polyethylene film or ribbon 202 the rotating brush roll 200 applies a plurality of disruptive forces to the polyethylene film or ribbon 202 substantially in the direction of the movement of the polyethylene film or ribbon 202 to split the polyethylene film or ribbon 202 into a fibrous structure.

Processing of short natural fibers like pulp, eucalyptus, bamboo typically involves multiple steps, including the steps of cleaning, scouring, and wet laying of the fibrous material. Accordingly, preparing absorbent devices such as baby diapers, incontinence and catamenial devices, from these short natural fibers can be very involved and costly. An absorbent device derived from pulp, for example, is conventionally made by first making a pulp sheet of a dense, board-like nature, which typically is made by wet-laying the pulp and then making a rolled up bale of pulp from that with the aid of vacuum suction and drying. The rolled up bale of pulp is subsequently disintegrated with a special device to make a fluff pulp. After the disintegration step, the fluff pulp is air-laid either directly on an appropriately sized wire screen; or, more typically, the pulp is air-laid on a tissue sheet on a wire to form an air-laid sheet. Afterwards, the air-laid sheet is cut up into a desired product shape.

WO 1997/004162 by Rayonier, Inc. discloses a method which eliminates the step of pulp fluffing but introduces a chemical treatment step. In this method, pulp is first treated with a cold caustic solution to produce a cold caustic extracted pulp, which is wet laid to obtain a wet laid cold caustic extracted pulp sheet. The wet laid cold caustic extracted pulp sheet is then dried to form a dry pulp sheet suitable for incorporation in an absorbent device.

Although much has been learned about natural fiber processing, there exists a need for newer and more efficient and economic machines and dry processes for processing natural fibers that eliminate the multiple steps in product formation and/or produce longer, fine denier fibers, especially directly from natural fibers with substantial amount of connective [plant] tissue and/or resinous coating.

### BRIEF SUMMARY OF THE INVENTION

Provided is a fiber refining machine and a method of using the same. The fiber refining machine including a fiber feeding assembly, a rotary brush assembly and a rotary cutter assembly. The fiber feeding assembly comprises a feeding nip formed between a rotatable roll a nose bar and configured to feed a fibrous material through the nip. The rotary brush assembly includes a wire wheel positionable downstream of the feeding nip and configurable to comb the fed fibrous material to remove connective tissue and/or resinous coating therefrom and to separate the combed fibrous material into individual fibers. The rotary cutter assembly includes at least one rotatable knife and a stationary anvil, the rotary cutter assembly configurable to receive and cut the separated individual fibers into predetermined lengths.

In at least one embodiment, the present invention provides fiber refining machine comprising: a fiber feeding assembly comprising a rotatable feed roll having a circumferential surface; and a bar having a body, the body having a leading end, a trailing end, and a body surface extending from the trailing end to the leading end, the bar being disposed sufficiently adjacent to the feed roll such that at least a portion of its body surface forms a nip with the circumferential surface of the rotatable feed roll, the nip being configured to receive and feed a fibrous material along a first direction; and a rotary brush positioned downstream of the fiber feeding assembly proximate a leading face of the bar and configured to contact and comb the fibrous material against at least a portion of the leading face of the bar in order to remove connective tissue and/or resinous coating from the fibrous material and separate the fibrous material into individual fibers.

In at least one embodiment of the fiber refining machine, feed roll is connected to a drive motor which is configured to provide a rotational force for rotating the feed roll to feed the fibrous material between the feed roll and the bar when the drive motor is operational.

In at least one embodiment of the fiber refining machine, the circumferential surface of the feed roll includes a traction enhancing coating on at least a portion thereof.

In at least one embodiment of the fiber refining machine, the circumferential surface of feed roll is textured. In a further embodiment, the textured circumferential surface of the feed roll comprises knurls, grooves, or a combination of both.

In at least one embodiment, the fiber refining machine in accordance with the present invention further includes an adjusting device operatively coupled to the fiber feeding assembly and configured for adjusting the nip gap between the body surface of the bar and the circumferential surface of the rotatable feed roll in accordance with the thickness of the fibrous material to be fed. In a further embodiment, the adjusting device comprises an adjustable spring loading mechanism for use in controlling the gap between the body surface of the bar and the circumferential surface of the rotatable feed roll. In another embodiment, the adjusting device is pneumatically coupled to the bar and configured to pneumatically control the nip gap between the body surface of the bar and the circumferential surface of the rotatable feed roll by controlling air pressure directed to the bar through an airline from a pneumatic pressure source.

In at least one embodiment of the fiber refining machine, the fiber feeding assembly includes a frame and the rotatable feed roll is rotatably mounted on the frame adjacent the bar.

In a further embodiment of the fiber refining machine, the frame includes a fulcrum shaft to which the bar is pivotably mounted adjacent the feed roll so as to allow for pivotal movement of the bar towards and away from the feed roll.

### BRIEF DESCRIPTION OF THE SEVERAL VIEWS OF THE DRAWINGS

The foregoing summary, as well as the following detailed description of embodiments of the fiber refining machine, will be better understood when read in conjunction with the appended drawings of an exemplary embodiment. It should be understood, however, that the invention is not limited to the precise arrangements and instrumentalities shown.

In the drawings:

FIG. 1A is a perspective view of a fiber refining machine in accordance with an exemplary embodiment of the present invention;

FIG. 1B is a side view of the fiber refining machine shown in FIG. 1A;

FIG. 2 is a side view of a feed assembly, rotary brush assembly and rotary cutter assembly of the fiber refining machine shown in FIGS. 1A and 1B;

FIG. 3 is a perspective view of a fiber feeding assembly and a rotary brush assembly in accordance with the exemplary fiber refining machine shown in FIG. 1A;

FIG. 4A is a schematic perspective view of the fiber feeding assembly and the rotary brush assembly in accordance with the exemplary embodiment shown in FIG. 3;

FIG. 4B is a schematic side view of the fiber feeding assembly and the rotary brush assembly in accordance with the exemplary embodiment shown in FIG. 4A;

FIG. 5 is a perspective view of a drive mechanism operatively connected to the rotary brush of the exemplary fiber refining machine shown in FIG. 1A;

FIGS. 6A and 6B illustrate a drive mechanism operatively connected to the rotary to the fiber feeding assembly of the exemplary fiber refining machine shown in FIG. 1A;

FIG. 7 is another schematic side view of the fiber feeding assembly and the rotary brush assembly in accordance with the exemplary embodiment shown in FIG. 2;

FIGS. 8A-8C are side views illustrating various geometries of nose bar in accordance with the exemplary embodiments of the present invention;

FIG. 9 is a schematic side view of rotary cutter in accordance with an exemplary embodiment of the present invention;

FIG. 10 is a schematic side view of Prior Art feed mechanism for a carding machine; and

FIG. 11 is a schematic side view of a Prior Art machine for splitting plastic sheet materials.

### DETAILED DESCRIPTION OF THE INVENTION

As used here in the specification and the claims, the terms “resinous coating”, “outer coating”, and variants thereof, include any undesired adjunct to useful natural fiber, including, without limitation, connective tissue, plant tissue, and the like.

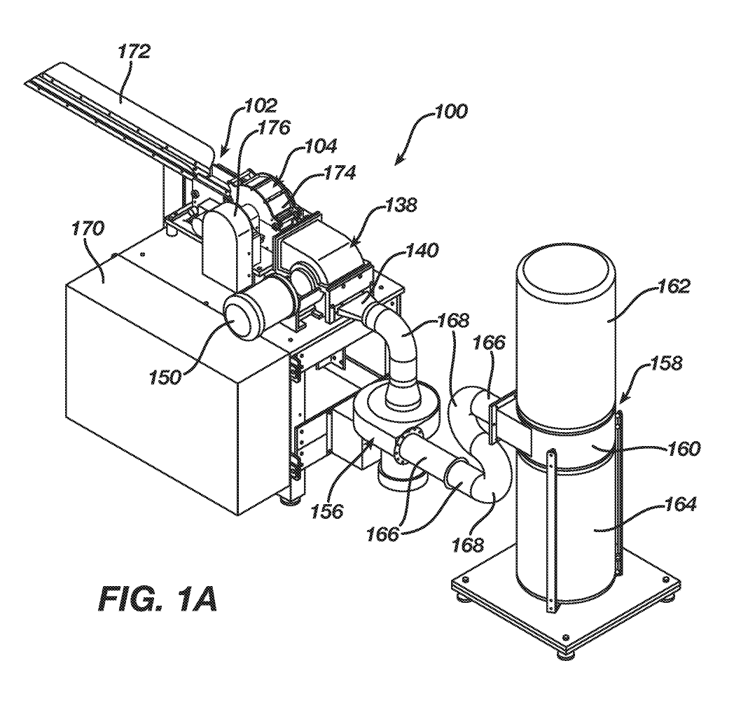

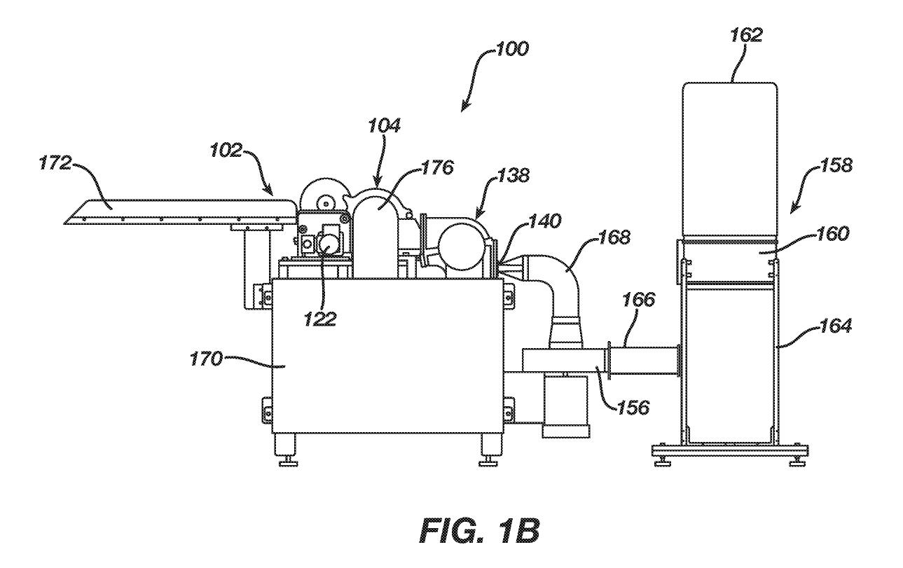

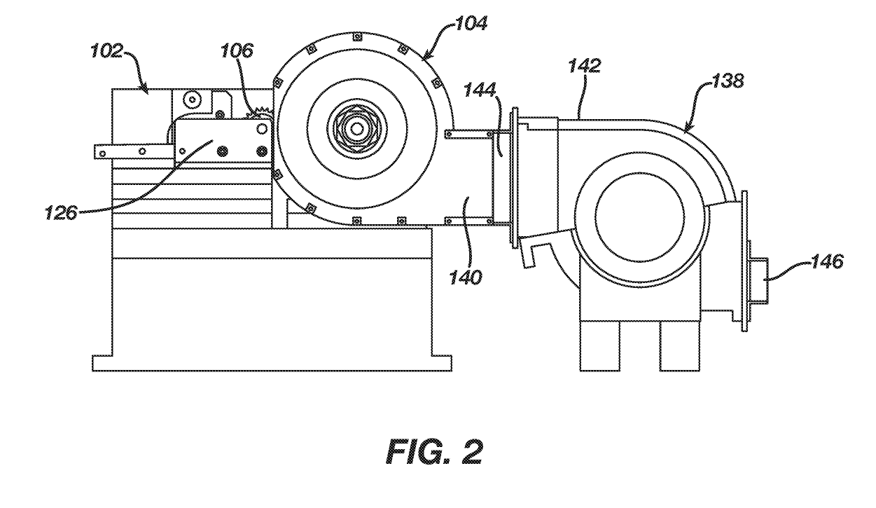

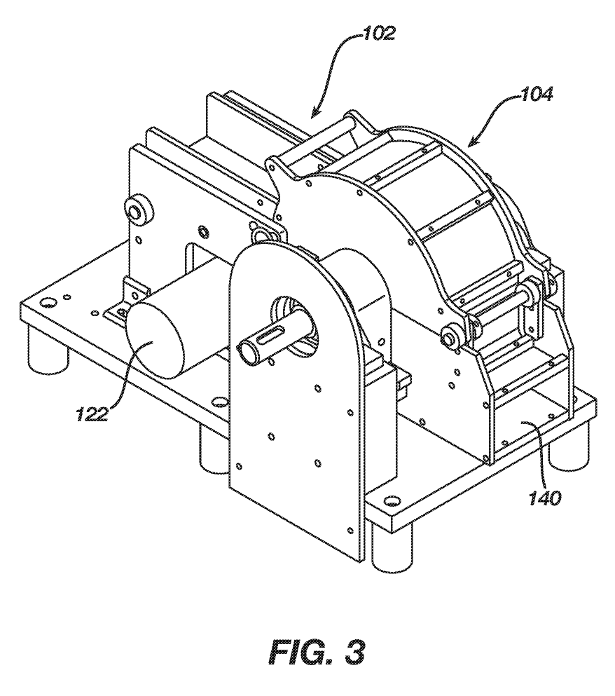

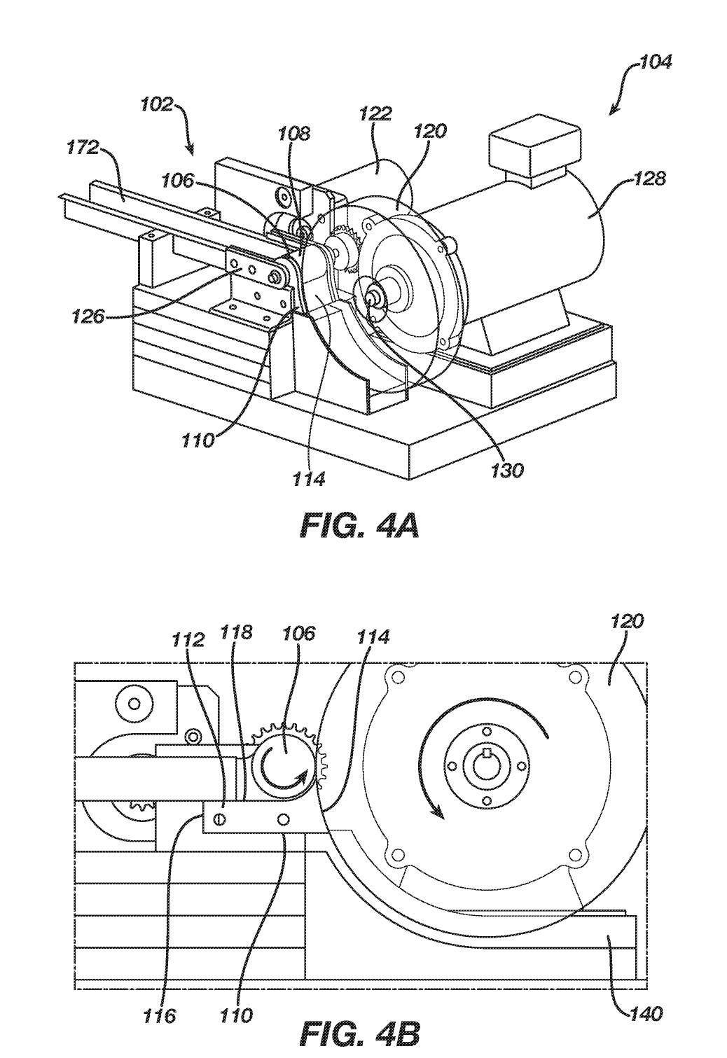

Referring to the drawings in detail, wherein like reference numerals indicate like elements throughout, there is shown in FIGS. 1A-9 a fiber refining machine, generally designated with reference numeral 100, in accordance with an exemplary embodiment of the present invention. Referring to FIGS. 1A and 1B, in an exemplary embodiment, the fiber refining machine 100 includes a fiber feeding assembly 102 and a rotary brush assembly 104 disposed proximate the fiber feeding assembly 102. In one embodiment, as illustrated in FIG. 2, the fiber feeding assembly 102 and the rotary brush assembly 104 are interconnected to allow fibrous material from the fiber feeding assembly 102 to be received and be processed by the rotary brush assembly 104. In accordance with this embodiment, the fiber feeding assembly 102 includes a rotatable feed roll 106, as shown in FIGS. 4A and 4B, having a circumferential surface 108; and a nose bar 110 having a body 112, the body 112 having a leading end 114, a trailing end 116, and a body surface 118 extending from the trailing end 116 to the leading end 114, the nose bar being disposed sufficiently adjacent to the feed roll 106 such that at least a portion of its body surface forms a nip with the circumferential surface 108 of the rotatable feed roll 106, the nip being configured to receive and feed a fibrous material along a feed path.

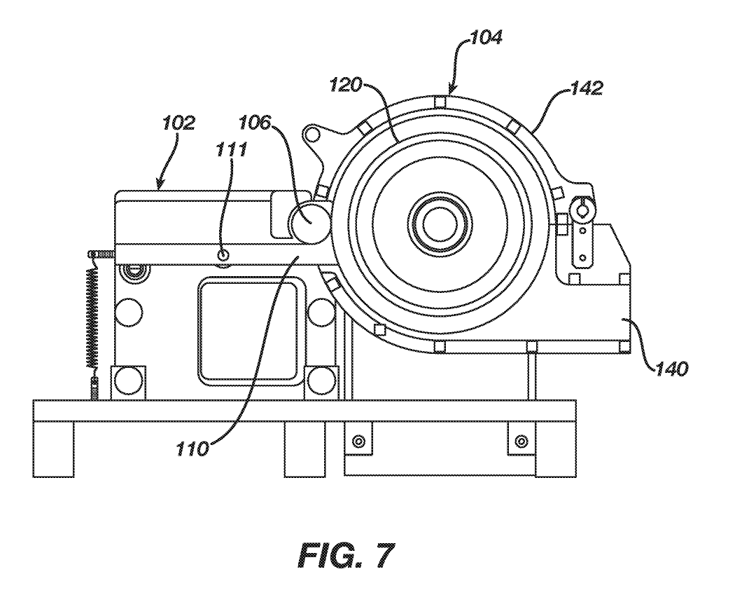

As illustrated in FIGS. 4A, 4B, and 7, the fiber refining machine includes a rotary 120 brush positioned downstream of the feed roll 106 and nose bar 110 and arranged such that rotary brush 120 can contact and comb a fibrous material exiting the nip between the feed roll 106 and nose bar 110 against at least a portion of the peripheral surface of the leading end 114 of nose bar 110. This configuration advantageously allows the bristles of the rotary brush 120 to remove connective tissue and/or resinous coating from the fed fibrous material and to separate the fibrous material into individual fibers.

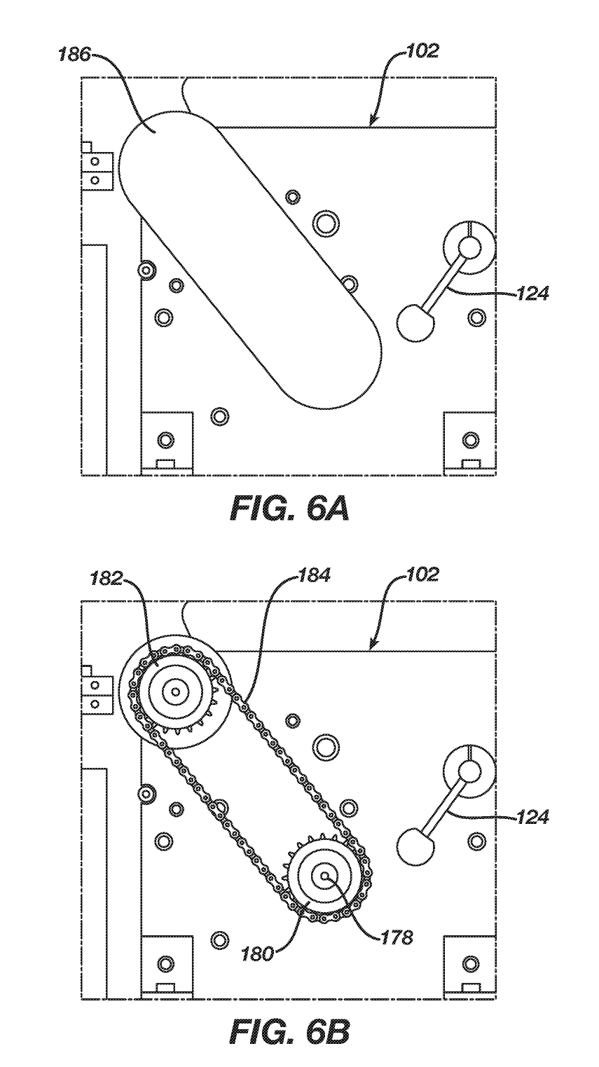

Referring to FIGS. 1B and 4A, in one embodiment of the fiber refining machine 100 of the present invention, as illustrated in FIG. 4A, the feed roll 106 is connected to a drive motor 122 which is configured to provide a rotational force for rotating the feed roll 106 to feed fibrous material between the feed roll 106 and the nose bar 110 when the drive motor 122 is in operation. Alternatively, the feed roll 106 may be connected to the drive motor 122 via a drive mechanism which includes a drive gear which transmits rotational motion to the feed roll 106 from the drive motor 122, in turn is connected to a power source. In yet another embodiment, see FIG. 6B, the feed roll 106 is driven by a drive chain and sprocket type mechanism in which the drive motor 122 includes a drive shaft 178 and a drive sprocket 180 drivingly connected therewith while feed roll 106 is coupled to a driven sprocket 182 with teeth for engaging a drive chain 184, which in turn is coupled with drive sprocket 180 and configured to transmit rotational motion to the feed roll 106 from the drive motor 122.

In order to facilitate the feed process, in one embodiment, the peripheral surface 108 of the feed roll 106, as illustrated in FIG. 4A, has a traction enhancing coating (not shown) on at least a portion thereof. In an alternative embodiment, the peripheral surface 108 of the feed roll 106 is textured. In yet another embodiment, the peripheral surface 108 of the feed roll 106, as illustrated in FIG. 4A, is provided with knurls, grooves, or a combination of both (not shown).

Referring to FIGS. 6A, 6B, and 7, in one embodiment, the fiber refining machine of the present invention may include an adjusting device 124 operatively coupled to the fiber feeding assembly 102 and configured for adjusting the nip gap between the peripheral surface 108 of the feed roll 106 and the body surface 118 of nose bar 110 in accordance with the thickness of the fibrous material to be fed through the nip. In one embodiment, as shown in FIG. 7, the adjusting device 124 includes an adjustable spring loading mechanism for use in controlling the gap between the peripheral surface 108 of the feed roll 106 and the body surface 118 of nose bar 110. Alternative embodiments for the adjusting device 124 are contemplated, including an adjusting device which is pneumatically coupled to the nose bar 110 and configured to pneumatically control the nip gap between the peripheral surface 108 of the feed roll 106 and the body surface 118 of nose bar 110 by controlling air pressure directed to the nose bar 110 through an airline from a pneumatic pressure source.

Referring to FIGS. 2 and 4A, in one embodiment of the fiber refining machine 100, as shown in FIG. 4A, the fiber feeding assembly 102 includes a frame 126 on which the rotatable feed roll 106 is rotatably mounted adjacent the nose bar 110. In one embodiment, as shown in FIG. 7, the frame 126 includes a fulcrum shaft 111 mounted thereon and to which the nose bar 110 is pivotably mounted adjacent the feed roll 106 so as to allow for pivotal movement of the nose bar 110 towards and away from the feed roll. Such an arrangement advantageously allows an operator to modulate the flow of fibrous material through the nip between feed roll 106 and nose bar 110 by increasing or decreasing the nip gap between them and also allows the operator to disengage the nose bar 110 from feed roll 106 to prevent erosion of any traction coating, knurls or the like on the peripheral surface 108 of feed roll 106 when no fibrous material is being fed through the nip.

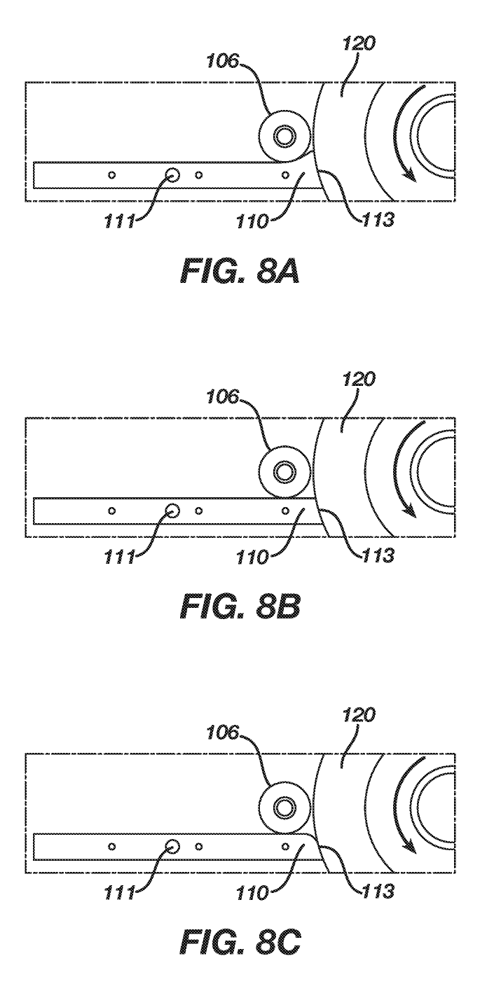

As illustrated in FIGS. 8A-8C, geometry of the nose bar 110 at the leading end 113 may be varied to increase or decrease the surface area over which rotary brush 120 can comb fibrous material being fed through the nip between the feed roll 106 and the nose bar 110. This advantageously provide an operator with flexibility to use nose bar geometry that would optimize fiber refining regardless of the amount of connective tissue and/or resinous material coating the fibrous materials being fed into the machine.

In some embodiments of the fiber feeding assembly 102, feed roll 106 is driven by the drive motor 122 with an adjustable rotational speed controlled by a control module (not shown). In one embodiment, the drive motor 122 is coupled with a potentiometer (not shown) which is configured to establish a desired rotational speed of the drive motor 122, which in turn establishes the rotational speed of the feed roll 106. In one embodiment of the fiber feeding assembly 102, when the feed roll 106 is in use, its tangential speed rate, which corresponds to fiber feed rate, is preferably in the range of from about 1 meter per minute (1 m/min) to about 10 meters per minute. However, the fiber feed rate is not limited to the stated range since the fiber feeding assembly 102 is operable even at feed rates outside the range. Also, a person of ordinary skill would recognize that depending on the density of the connective tissue and/or resinous coating to be removed from the fibrous material being processed and other considerations, a useful feed rate for the fiber feeding assembly 102 may fall outside of the stated range of about 1 m/min to about 10 m/min.

Referring to FIG. 4A, in one embodiment, as shown in FIG. 4A, the fiber refining machine 100 includes a drive motor 128 operatively connected to the rotary brush 120 and configured to provide a rotational force for rotating the rotary brush 120 at a predetermined rotational speed. In one embodiment, the drive motor 128 is configured to provide a rotational force for rotating the rotary brush 120 such that the rotary brush 120 velocity is preferably in the range from about 300 m/min to about 2,400 m/min. However, the velocity of the rotary brush 120 is not limited to the stated range since the rotary brush 120 is operable even at velocities outside the stated range. Also, a person of ordinary skill would recognize that depending on the density of the connective tissue and/or resinous coating to be removed from the fibrous material being processed and other considerations, a useful velocity for the rotary brush 120 may fall outside of the stated range of about 300 m/min to greater about 2,400 m/min.

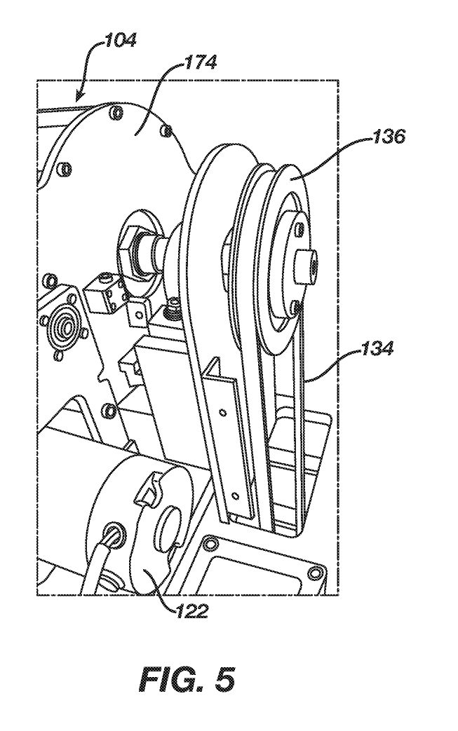

In one embodiment, as shown in FIG. 4A, the drive motor 128 includes a drive shaft 130 having a drive pulley 132 (FIG. 5, drive pulley not shown), a drive belt 134 wrapped around the drive pulley 132 while the rotary brush 120 is coupled to a rotary brush pulley 136 and connected to the drive pulley 132 with the drive belt 134. The drive belt 134 is configured to transmit rotational motion to the rotary brush 120 from the drive motor 128 when the drive motor 128 is in operation. Other embodiments of the driving mechanism are contemplated, a drive chain and sprocket type mechanism in which the drive motor 128 would include a drive shaft and drive sprocket drivingly connected therewith while the rotary brush 120 would include a driven sprocket with teeth for engaging a drive chain which would connect the drive sprocket with the driven sprocket.

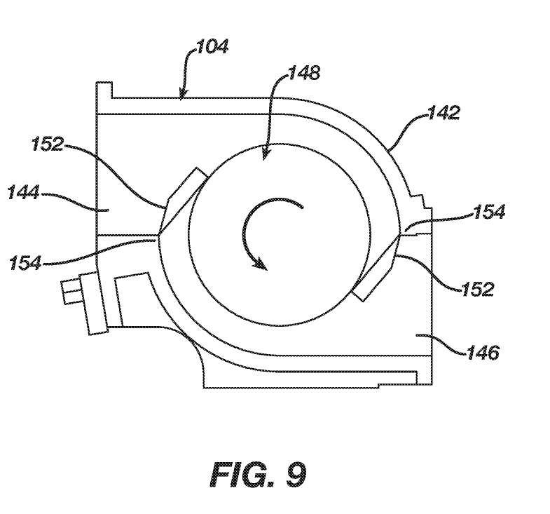

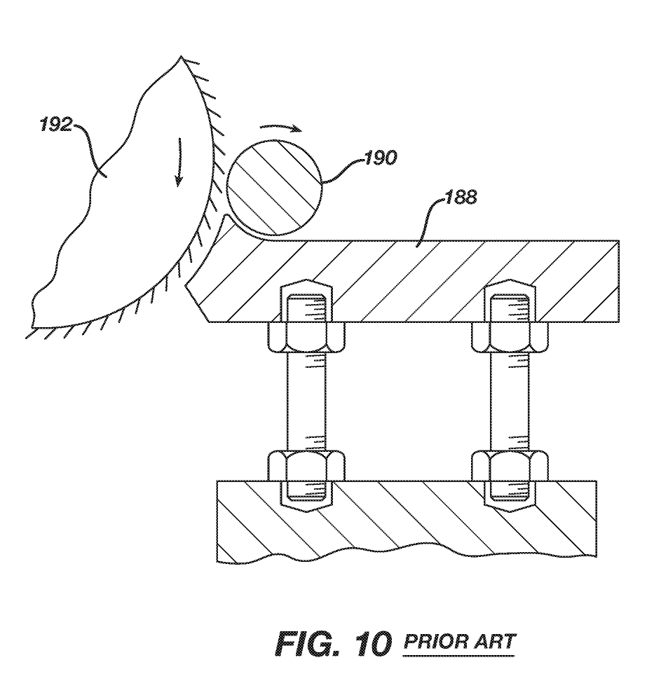

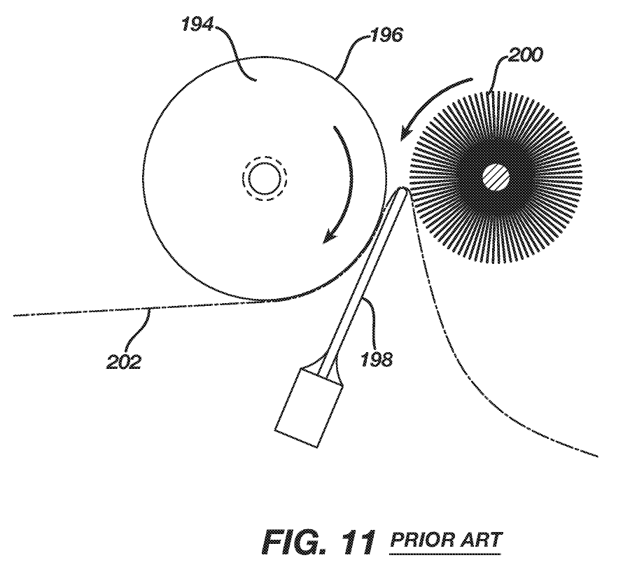

Referring to FIGS. 1A to 3, and 9, in one embodiment, the fiber refining machine 100 includes a rotary cutter assembly 138 adapted for transversely severing the individually separated fibers exiting an outlet port 140 of the rotary brush assembly 104 to produce fibers having predetermined dimensions when in operation, the rotary cutter assembly 138 being disposed downstream of the rotary brush assembly 104. In one embodiment, as illustrated in FIG. 2, the rotary cutter assembly 138 includes a housing 142 having an inlet port 144 and outlet port 146 interconnected with the inlet port 142. The rotary cutter assembly 138 includes and a rotary knife assembly 148 rotatably mounted within the housing 142 with its rotational axis transversely disposed relative to the direction of feed of the fibrous material. As shown in the embodiment of FIG. 9, the rotary knife assembly 148 includes a pair of radially oriented knives 152 which are configured to cooperate with anvils 154 to transversely cut the individually separated fibers exiting outlet port 140 of rotary brush assembly 104 into fiber segments of a predetermined lengths determined by the rotational speeds the feed roll 106 and the rotary knife assembly 148.

Referring to FIGS. 1A and 9, in one embodiment, the fiber refining machine 100 includes a drive motor 150 operatively connected to the rotary knife assembly 148 (FIG. 9) and configured to provide a rotational force for rotating the rotary knife assembly 148 at a predetermined rotational speed. In some embodiments, the rotary knife assembly 148 is driven by the drive motor 150 with an adjustable rotational speed controlled by a control module. In some embodiments, the drive motor 150 is coupled with a potentiometer which is configured to establish a desired rotational speed of the drive motor 150, which in turn establishes the rotational speed of the rotary knife assembly 148. In some embodiments, when the rotary knife assembly 148 is in use, it is configured to perform cuts at a rate ranging from about 100 cuts per minute to about 7,500 cuts per minute.

Referring to FIGS. 1A and 1B, in one embodiment, the fiber refining machine 100 of the present invention includes a pneumatic pressure source 156 pneumatically coupled to the rotary cutter assembly 138 and configured to provide pneumatic negative pressure (p) at the outlet port 140 of the rotary cutter assembly 138 so as to pneumatically convey dust and cut fiber segments away from the rotary cutter 138 and into a collection container, for example. In some embodiments, the fiber refining machine 100, further includes a cyclone dust collector assembly 158 pneumatically coupled to the pneumatic pressure source 156, which in turn is interconnected with the rotary cutter assembly 138. In one embodiment, as illustrated in FIG. 1A, the cyclone dust collector assembly 158 includes a cyclone 160 for receiving and centrifugally separating dust and/or dirt from air sucked from the rotary cutter assembly 138, by the pneumatic pressure source 156, a first dust receptacle 162 for collecting the separated dust and/or dirt, and second receptacle 164 for collecting heavier cut fiber segments. As shown in FIGS. 1A and 1B, interconnected hollow pipes 166 and elbows 168 define the flow path of vacuum from the rotary cutter assembly 138 to the cyclone dust collector assembly 158. Alternatively, instead of collecting cut fiber segments into receptacle 164, the cut fiber segments could be directly processed into an absorbent web as, for example, by airlaying the cut fiber segments onto a screen or the like and then the web could be calendared to a desired density. Also, the web could be cut into a desired length and/or further processed into various absorbent products.

Referring to FIGS. 1A and 1B, in one embodiment, the fiber refining machine 100 of the present invention may include a stand-alone power source 170, e.g., an electric generator or a battery, for supplying electric power to various components of the fiber refining machine 100. Alternatively, the fiber refining machine 100 may be provided with electric power from an electric power source that is not necessarily part of the machine. Also, the fiber refining machine 100 may optionally include a feed tray 172 associated with the fiber feeding assembly 102 to hold and channel bundles of fibrous material into the fiber feeding assembly 102.

As illustrated in FIGS. 1A, 1B, 4A, and 7, the fiber refining machine 100 may include safety covers for covering electrical connectors or connections and moving parts of the machine. Accordingly, the rotary brush 120 is rotatably mounted within a housing 174; the rotary knife assembly 148 (FIG. 9) is mounted within the housing 142 (FIG. 9); the drive pulley 132, the drive belt 134, and the driven pulley 136 are all housed within protective cover 176; and the drive shaft 178, the drive sprocket 180, the driven sprocket 182, and the drive chain 184 are all housed in protective cover 186 (see FIG. 6A).

In another aspect, the present invention provides a method of refining natural fiber materials including, but not limited to, fiber bundles derived from bagasse, banana stalks, plantain stalks, Cavendish plant stalks, pineapple crowns, coconut fronds, palmetto fronds and palm fronds. Harvesting methods and post-harvest treatment methods for plants containing natural fibers are well known to those skilled in the art. Accordingly, the method of the present invention will be primarily described with references to banana tree fibers but it should be appreciated that the method of the present invention also can be used to refine natural fibers from other natural sources including bagasse, banana stalks, plantain stalks, Cavendish plant stalks, pineapple crowns, coconut fronds, palmetto fronds and palm fronds. A method of processing harvested banana tree stalks is described in U.S. Pat. No. 9,068,180, by Geophia LLC, which is incorporated by reference herein in its entirety. After banana fruits are harvested from banana trees, banana tree stalks are cut down, leaves are removed from them, and the banana tree stalks are cut into thick ribbons. The ribbons are processed to reduce their moisture content, for example, by feeding them into a calendar unit that squeezes out liquids, connective tissue and other cellular materials from the core fiber stands. The core fiber strands are air and/or sun dried and then packed into canvas bags. These dried banana fiber strands, however, are still covered with varying amounts of residual resinous coating and/or connective/plant tissue, which must be removed to produce fibers that are suitable for making absorbent articles.

In one embodiment, the method of refining natural fiber materials according to the present invention, comprises feeding the dried banana fiber strands into a nip formed between a rotatable feed roll and a tangentially proximate nose bar along a feed path; and combing the fed dried banana fiber strands against a peripheral surface of the nose bar as it exits the nip with rotatable brush wheel disposed tangentially proximate the nip and along the feed path. The brushing action removes connective tissue and/or resinous coating from the dried banana fiber strands and separates the dried banana fiber strands into individual fibers.

In one embodiment, the feeding step is carried out with a feed roll connected to a drive motor which is configured to provide a rotational force for rotating the feed roll to feed dried banana fiber strands between the feed roll and the nose bar. In order to facilitate feeding of dried banana fiber strands, at least a portion of the peripheral surface of the feed roll may be covered with a traction enhancing coating to increase frictional contact between the fibrous material and the peripheral surface of the feed roll. Alternatively, the peripheral surface of feed roll may be textured, for example, with knurls, grooves, or a combination of both.

In one embodiment, the feed rate of the feeding step may be modulated by an adjusting device operatively coupled to the nose bar and configured for adjusting the nip gap between the rotatable feed roll and the nose bar in accordance with the thickness of the fibrous material being fed through the nip. In one embodiment, the adjusting device may comprise an adjustable spring loading mechanism for use in controlling the nip gap by moving the nose bar away or towards the rotatable feed roll. In yet another embodiment, the adjusting device may be pneumatically coupled to the nose bar and configured to pneumatically control the nip gap between the nose bar and the rotatable feed roll by controlling an air pressure directed to the nose bar through an airline from a pneumatic pressure source.

In some embodiments of the fiber refining method, the feed roll in the feeding step may be connected to a drive mechanism which includes a drive gear which transmits rotational motion to the feed roll from a drive motor that is in turn connected to a power source. In some preferred embodiments of the fiber refining method, in operation, the feed roll can be configured to achieve a fiber feed rate ranging from about 1 meter per minute (1 m/min) to about 10 meters per minute.

In some embodiments of the fiber refining method, in the combing step, the rotary brush may be operatively connected to a drive motor which is configured to turn the rotary brush at a predetermined rotational speed when in operation. In one such embodiment, when in use, the rotary brush can be configured to achieve a preferred velocity ranging from about 300 m/min to about 2,400 m/min.

In some embodiments of the fiber refining method, the drive mechanism for driving the rotary brush may include the motor including a drive shaft and a drive pulley drivingly connected therewith while the rotary brush would include a driven pulley connected to the drive pulley with a drive belt.

In some embodiments, the fiber refining method further includes the step of transversely cutting the individually separated fibers into fiber segments having predetermined dimensions with a rotating cutter disposed proximate the rotary brush along the feed path of dried banana fiber strands. The cut fiber segments may pneumatically conveyed to a collection receptacle by the application of a negative pneumatic pressure along the feed path downstream of the rotating cutter. Dust and/or dirt may be separated from the cut fiber segments by pneumatically passing air-laden with the dust, dirt and cut fiber segments through a cyclone dust collector assembly to centrifugally separate the dust from the cut fiber segments.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the fiber refining method disclosed herein does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A fiber refining machine comprising:
a fiber feeding assembly comprising:
(i) a rotatable feed roll having a circumferential surface; and
(ii) a bar having a body, the body having a leading end, a trailing end, and a body surface extending from the trailing end to the leading end,
the bar being disposed adjacent to the feed roll such that at least a portion of its body surface forms a nip with the circumferential surface of the rotatable feed roll,
the nip being configured to receive and feed a fibrous material along a first direction; and
a rotary brush positioned downstream of the fiber feeding assembly proximate a leading face of the bar and configured to contact and comb the fibrous material against at least a portion of the leading face of the bar in order to remove connective tissue and/or resinous coating from the fibrous material and separate the fibrous material into individual fibers.

2. The fiber refining machine of claim 1, wherein the feed roll is connected to a drive motor which is configured to provide a rotational force for rotating the feed roll to feed the fibrous material between the feed roll and the bar when the drive motor is in operation.

3. The fiber refining machine of claim 1, wherein the circumferential surface of the feed roll has a traction enhancing coating on at least a portion thereof.

4. The fiber refining machine of claim 1, wherein the circumferential surface of feed roll is textured.

5. The fiber refining machine of claim 4, wherein the textured circumferential surface of the feed roll comprises knurls, grooves, or a combination of both.

6. The fiber refining machine of claim 1, further including an adjusting device operatively coupled to the fiber feeding assembly and configured for adjusting the nip gap between the body surface of the bar and the circumferential surface of the rotatable feed roll in accordance with the thickness of the fibrous material to be fed.

7. The fiber refining machine of claim 6, wherein the adjusting device comprises an adjustable spring loading mechanism for use in controlling the gap between the body surface of the bar and the circumferential surface of the rotatable feed roll.

8. The fiber refining machine of claim 6, wherein the adjusting device pneumatically coupled to the bar and is configured to pneumatically control the nip gap between the body surface of the bar and the circumferential surface of the rotatable feed roll by controlling air pressure directed to the bar through an airline from a pneumatic pressure source.

9. The fiber refining machine of claim 1, wherein the fiber feeding assembly includes a frame and the rotatable feed roll is rotatably mounted on the frame adjacent the bar.

10. The fiber refining machine of claim 9, wherein the frame includes a fulcrum shaft to which the bar is pivotably mounted adjacent the feed roll so as to allow for pivotal movement of the bar towards and away from the feed roll.

11. The fiber refining machine of claim 1, wherein the feed roll is connected to a drive mechanism including a drive gear which transmits rotational motion to it from a drive motor that is in turn connected to a power source.

12. The fiber refining machine of claim 2 or claim 11, wherein when the feed roll is in operation it feeds fiber at a feed rate ranging from about 1 meter per minute (1 m/min) to about 10 m/min.

13. The fiber refining machine of claim 1, further including a motor operatively connected to the rotary brush so as to turn the rotary brush at a predetermined rotational speed.

14. The fiber refining machine of claim 13, wherein, when in operation the rotary brush has a velocity ranging from about 300 m/min to about 2,400 m/min.

15. The fiber refining machine of claim 13, wherein the motor includes a drive shaft having a drive pulley, and the rotary brush includes a rotary brush pulley connected to the drive pulley with a rotary brush drive belt.

16. The fiber refining machine of claim 13, wherein the motor includes a drive shaft having a drive sprocket, and a drive chain, the drive sprocket drivingly connected with the motor shaft; wherein the rotary brush includes a driven sprocket with teeth for engaging the drive chain which connects the drive sprocket with the driven sprocket.

17. The fiber refining machine of claim 1, further including a rotary cutter assembly for transversely severing the individually separated fibers exiting the rotary brush assembly to produce fibers having predetermined dimensions when in operation, the rotary cutter assembly being disposed downstream of the rotary brush assembly, and wherein the rotary cutter assembly includes a housing and a rotary knife assembly rotatably mounted therein in a manner that positions its rotational axis transverse to the direction of feed of the individually separated fibers.

18. The fiber refining machine of claim 17, wherein the rotary knife assembly comprises a body having a first end and a second end spaced from the first end, and a knife element mounted on each of the first and second ends so that when the rotary knife assembly is rotated about its longitudinal axis, the rotating knives transversely sever the individually separated fibers into fiber segments of a predetermined lengths as they exit the rotary brush and are fed into the rotary cutter assembly.

19. The fiber refining machine of claim 17, further including a pneumatic pressure source pneumatically coupled to the rotary cutter assembly and configured to provide pneumatic negative pressure at an outlet port of the rotary cutter so as to pneumatically convey dust and cut fiber segments away from the rotary cutter.

20. The fiber refining machine of claim 17, further including a cyclone dust collector assembly pneumatically coupled to the pneumatic pressure source and the rotary cutter assembly, the cyclone dust collector assembly including a cyclone for receiving and centrifugally separating dust or dirt from air sucked from the rotary cutter assembly by the pneumatic pressure source, a first dust receptacle for collecting the separated dust or dirt, and second receptacle for collecting heavier cut fiber segments.

21. A method of refining natural fiber comprising:
feeding a fibrous material into a nip formed between a rotatable feed roll and a tangentially proximate nose bar along a feed path; and combing the fed fibrous material against a peripheral surface of the nose bar as it exits the nip with rotatable brush wheel disposed tangentially proximate the nip and along the feed path to remove connective tissue and/or resinous coating from the fibrous material and to separate the fibrous material into individual fibers.
